(19) United States
(12) Patent Application Publication
(10) Pub. No.: US 2026/0300220 A1
(43) Pub. Date: Oct. 1, 2026

(54) GRANULAR ARCHIVING OF DATA FROM A MULTITENANT SYSTEM

(71) Applicant: Open Text Inc., Menlo Park, CA (US)

(72) Inventor: Zachery Michael Sogolow, Tacoma, WA (US)

(21) Appl. No.: 19/089,463

(22) Filed: Mar. 25, 2025

(51) Int. Cl. G06F 16/11; H04L 43/02; H04L 51/21

(52) U.S. Cl. CPC G06F 16/113; H04L 43/02; H04L 51/21

(57) ABSTRACT

Embodiments provide systems and methods for capturing data for archiving from a multitenant system. A definition of the data to capture may include a capture control option for controlling the users in a target tenant for which to capture data. A capture system retrieves the target users associated with the capture control option from the multitenant system and captures data for the target users from the multitenant system for archiving.

### TECHNICAL FIELD

Embodiments of the present disclosure relate to the archiving of data. Even more particularly, embodiments of the present disclosure relate archiving of data from multi-tenant systems. Even more particularly, embodiments relate to archiving data from multi-tenant online collaboration platforms.

### BACKGROUND

The use of multitenant, online platforms has exploded in recent years. While multitenant systems provide many advantages, they present unique issues with respect to data archiving of data from the multitenant environment.

An organization requiring data to be archived from a multitenant system may use archiving software to archive its data from the multitenant system. Typically, the archiving software is provided with tenant-level access to the organization’s data on the multitenant system, which is the highest level of access provided to tenants. The archiving software then archives data of all of the tenant’s members. There is no fine grain control over the users for which data is archived.

Some of the challenges with respect archiving data from multitenant systems can be illustrated using the example of a company acquired by a larger organization. In a common scenario for migrating a company into a larger organization, the domains and users of the acquired company are put under the global tenant of the larger organization. Regulations, legal obligations, or organizational policies may compel archiving of the acquired company’s data even after the merger is complete. However, because the data is now under the larger organization’s tenant, the archiving software requires tenant-level access to the surviving organization’s data. Consequently, the archiving software archives not only the data of the users from the acquired company but also data of all the preexisting users from the larger organization. As such, the archiving software may archive far more data than necessary, thereby using excessive processing resources and storage space and requiring significant post archiving processing to identify the actual data of interest (e.g., the data from the users of the acquired company).

What is desired then are systems and methods for electronic data archiving that allow for fine grain control over the data that is archived from a multitenant environment.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a network environment that includes a capture and archive system and a multitenant system.

FIG. 2 is a diagrammatic representation of one embodiment of a capture system.

FIG. 3A, FIG. 3B, FIG. 3C and FIG. 3D are diagrammatic representations of example embodiments of connections for controlling capture from a multitenant system.

FIG. 4 is flowchart illustrating one embodiment of a method for configuring data capture.

FIG. 5 is flowchart illustrating one embodiment of a method for capturing data.

FIG. 6 is a diagrammatic representation of one embodiment of a computer system.

### WRITTEN DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the present disclosure provide mechanisms for archiving data from multitenant platforms and provide a number of advantages over prior methods of archiving data from multitenant systems. Embodiments can provide fine grain control over the users for which data is captured based on various options including, but not limited to, user groups and domains. Using the example of archiving data for a company that was acquired and is now under the acquirer in the multitenant system, the users from the acquired company can be easily added to a user group at the multitenant system and then the user group used to control archiving. Embodiments can thus reduce or prevent the unnecessary capture and archiving of data, thereby reducing resource utilization (processing and memory usage) compared to capturing data for all the users in a tenant. Moreover, because data capture is controlled on the front end, less resources are required to locate data of interest in the archived data. Furthermore, embodiments can provide flexibility for determining the users for which to archive data by providing multiple options for determining users.

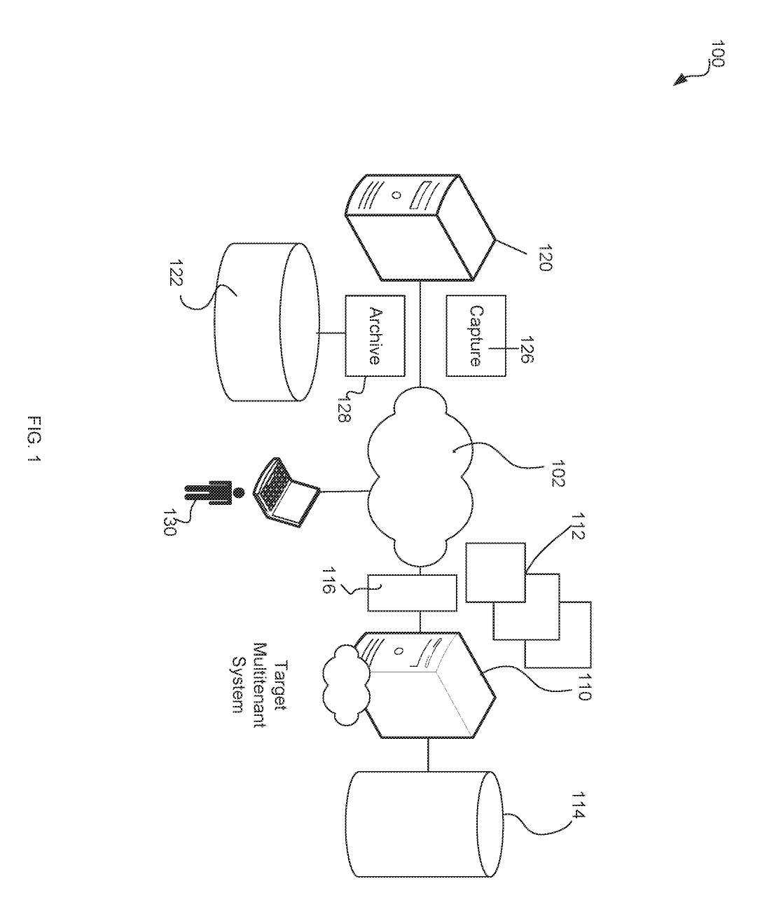

FIG. 1 is a diagrammatic representation of one embodiment of a network environment 100 that includes a multitenant system 110 that supports a large number of tenants and users and is accessible via network 102. In a typical multitenant scenario, multiple organizations (tenants) share one or more multitenant applications 112 provided by multitenant system 110. The tenant is provided with tenant level privileges, which is the highest level of access provided for a tenant. Users in a tenant can access multitenant applications 112 and access associated data with various levels of privileges to create, upload, collaborate on or otherwise use content (messages, files, records and other content), which is stored in a data store 114. Data store 114, according to one embodiment, is an object store that stores content as objects. Data store 114 may comprise, for example, one or more filesystems or databases or combinations thereof.

In many cases, members of the tenant—that is, users in the tenant—may be organized into user groups and users, user groups, and content under the tenant may be organized into various organizational structures (logical containers) that associate users (e.g., individual users or user groups) with content for purposes such as organization, communication and collaboration. These organizational structures act as containers for associated members and content (e.g., files, chat messages, or other content) and go by various names across software platforms, such as containers, spaces, channels, workspaces, teams, projects, organizations, hubs. Logical containers may have associated members, access rights, content (e.g., files, messages or other content). Logical containers (e.g., spaces, channels, workspaces, teams, projects, organizations, hubs) used for collaboration may be referred to as collaboration units. Multitenant system 110 provides an interface 116 (e.g., application programming interface (APIs) through which a tenant can query for information associated with the tenant, such as users, groups, logical containers, etc. belonging to the tenant.

Network environment 100 includes a capture and archive system 120 that provides tools to capture data from various sources and archive the captured data to an archival data store 122. Capture and archive system 120, for example, can interface with the various online multitenant platforms, such as, but not limited to collaboration or communication platforms, through any number of interfaces (e.g., application programming interfaces (API), etc.) to ingest content. Captured content can be stored to archival data store 122 in an archival data format. According to one embodiment, capture and archive system 120 implements a capture service 126 for capturing data from multitenant systems and an archiving service 128 for archiving data provided from various sources, such as capture service 126. In some embodiments, capture and archive system 120 is a cloud-based system.

At a high level, a user 130 wishing to archive data of a target tenant from multitenant system 110 accesses capture service 126 (e.g., via a web or other interface) and configures a capture job. User 130 preferably has sufficient privileges to grant capture service 126 capture permissions requested by capture service 126. In this context, capture permissions refer to the permissions necessary to allow capture of the data of interest of the target tenant from multitenant system 110.

According to one embodiment, user 130 provides capture service 126 with a tenant identifier used for a target tenant by multitenant system 110. Capture service 126 requests capture permissions for the target tenant and directs user 130 to an interface through which user 130 can approve permissions. Capture service 126 may, for example, request tenant level permissions for the target tenant (e.g., global access to the tenant’s data).

Capture service 126 provides user 130 with the option to elect to limit capture by capture control options. If user 130 elects to limit capture by options, capture service 126, in accordance with the capture permissions, queries multitenant system 110 for the users associated with the options and performs capture and archiving of content for the users associated with the options.

In one embodiment, capture service 126 provides user 130 with the option to limit capture by user groups. If user 130 elects to limit capture by user groups, capture service 126 queries multitenant system 110 through interface 116 for the user groups under the target tenant and presents the user groups to user 130 for selection. Based on user 130 selecting one or more groups, capture service 126 queries multitenant system 110 for the users who are members of the selected group and captures data (e.g., messages, files, or other content) for the members of the selected groups. User 130 may thus select the users for which to capture and archive data through selection of one or more user groups.

Capture service 126 may apply other options, such as domains or other options, for controlling the users for which data is collected and archived. In some embodiments, one or more of the capture control options are system specified options. For example, in some embodiments, the domains used for limiting data capture are not exposed to user 130. In other embodiments, user 130 may select one or more domains for limiting capture.

For a capture and archiving job, if no options are provided for controlling the users in the target tenant for which data is to be captured, the capture service 126 makes calls to interface 116 to retrieve all the users in the target tenant as target users. If options are provided for controlling the users in the target tenant for which data is to be captured, capture service 126 makes calls to interface 116 to retrieve users based on the options. For example, capture service 126 may retrieve the users in the target tenant having email addresses in specific domains, users who are members of specified groups, or users meeting other criteria. Capture service 126 uses the retrieved users as target users for capture and archiving.

Capture service 126 captures data for the target users from multitenant system 110. Capturing data for a target user may include, for example, capturing messages for which the user is a sender or a recipient, capturing content created owned or otherwise associated with user, capturing messages or other content from logical containers of which the user is a member. Messages, files, or other content may be captured from logical containers such as, but not limited to, spaces, channels, workspaces, teams, projects, organizations, hubs.

Capture service 126 can send captured data to archiving service 128 for archiving (e.g.,. according to an archival format). In one embodiment, capture service 126 sends captured data as email using, for example, envelope journaling format to encapsulate the captured data. Archiving service 128 archives the captured data to archival data store 122 using an archival format.

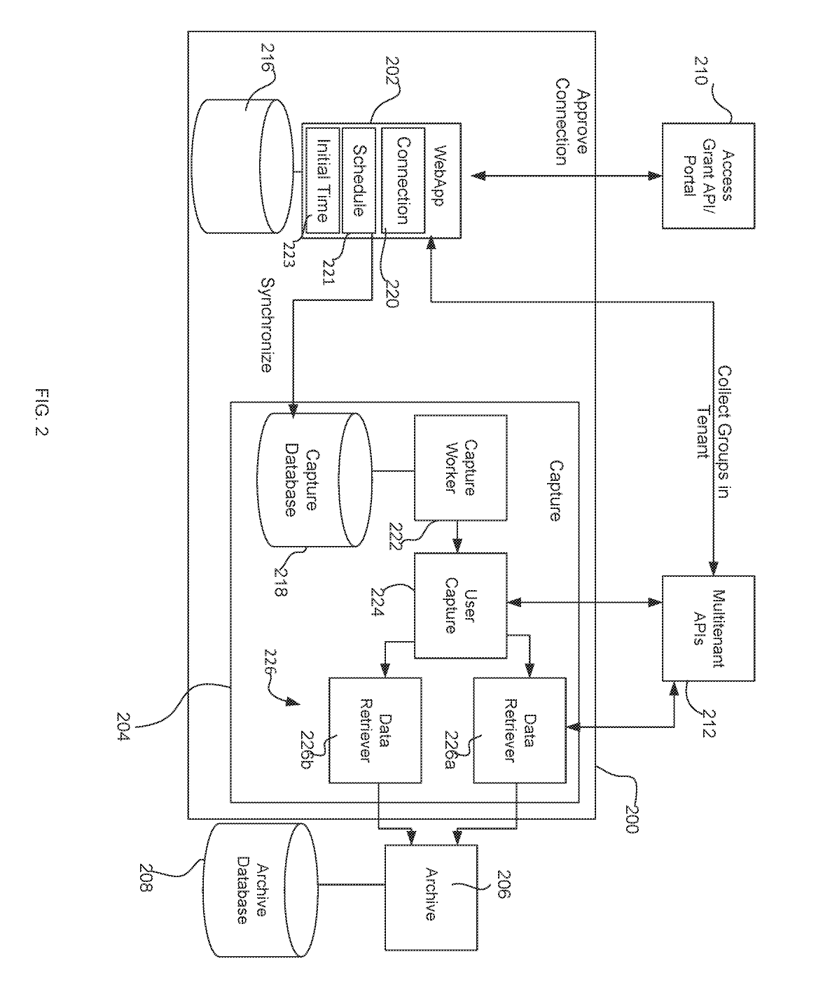

FIG. 2 illustrates one embodiment of a capture system 200, which, according to one embodiment, is a software system implemented through the execution of code by a processor (e.g., one or more processors of a cloud computing system or other computer system). Thus, capture system 200 may be embodied, in some embodiments, as computer-translatable instructions stored on a non-transitory, computer-readable medium. Capture system 200 may provide a capture service, such as capture service 126 of FIG. 1.

In the embodiment illustrated, capture system 200 includes a web application 202 for configuration and a capture component 204 for capturing data from a multitenant system (e.g., multitenant system 110 of FIG. 1). Capture system 200, according to one embodiment, provides captured data to an archiving application 206 for storage in archival storage 208.

Web application 202 provides an interface that allows a user (e.g., user 130) to create a connection 220 for data capture from a multitenant application. When configuring connection 220, a user (e.g., user 130) provides the tenant id or other indicator of a target tenant and, in some cases, selects capture control options for controlling the users in the target tenant for which data is captured. In some embodiments, the user can define an archive job that includes a connection and a schedule 221 (e.g., daily, hourly, etc.) for capture using the connection 220. The job may also include an initial time 223 indicating the earliest time from which data is to be captured. In another embodiment, the capture schedule may be system determined.

Web application 202 is configured to request capture permissions for the connection. According to one embodiment, the capture permissions are tenant level permissions for the target tenant. As will be appreciated, online services may use a variety of mechanisms to grant applications access to resources, and thus the mechanism used to receive capture permissions can vary by multitenant system or application.

In the embodiment of FIG. 2, web application 202 redirects the user to an interface through which the user can approve the permissions requested by capture system 200. For example, web application 202 may redirect the user to a portal 210 (e.g., portal for an authorization service provided by the provider of the target multitenant system or a third party) to allow the user to log in and approve the capture permissions.

According to one embodiment, when the user approves capture permissions, the authorization service issues an access token to web application 202, which in turn passes the access token to capture component 204. The workers of capture component 204 (e.g., user capture worker 224, data retriever 226a, data retriever 226b) use the token when making calls to access information via interface 212 (e.g., an API) of the multitenant system.

In another example, the multitenant system (e.g., multitenant system 110)_includes an application registration and an associated unique identifier and secret for capture system 200. When an end user, such as user 130, approves the capture permissions (e.g., via portal 210), the multitenant system registers the tenant with the application registration. Capture system 200 stores the identifier and secret for the application registration. During capture, capture component 204 (e.g., user capture worker 224) uses the identifier and secret to make an API call to retrieve an access token from the application registration by providing the identifier, secret, and the end user's tenant id on the request. According to one embodiment, the token is used for the duration of the capture run, and a new one will be retrieved using the same process on each subsequent capture run. According to one embodiment, the access rights stay associated with the application registration on the multitenant system indefinitely after the initial approval such that an end user (e.g., end user 130) would have to explicitly remove the connection from their tenant.

The user may be given the option to elect to control capture according to one or more capture control options. For example, the user may be given the option to control capture by user groups. In some embodiments, if the user elects not to control capture by user groups, connection 220 can be considered complete and stored to connection store 216.

If the user elects to control data capture by user group, web application 202 makes a call to interface 212 (e.g., an API) of the multitenant system to collect the user groups of the target tenant. For example, if the target tenant is a Microsoft Teams® tenant, web application 202 may query the Microsoft Graph API to collect the user groups of the target tenant (any tradenames, trademarks, service marks, certification marks, collective marks or the like used herein are the property of their respective owners). According to one embodiment, web application 202, at this point, simply collects the names or other identifiers of the user groups, but not the identities of the members.

Web application 202 presents the user with a capture form which, for example, allows the user to select the capture control options for controlling the users for which data is captured. For example, the capture form, according to one embodiment, allows the user to select groups to which to limit data capture. Based on user interaction with the user interface, web application 202 thus may receive a selection of one or more user groups and adds the user groups to connection 220. When the user indicates that they are done configuring connection 220, connection 220 may be considered complete and, for example, stored to connection store 216.

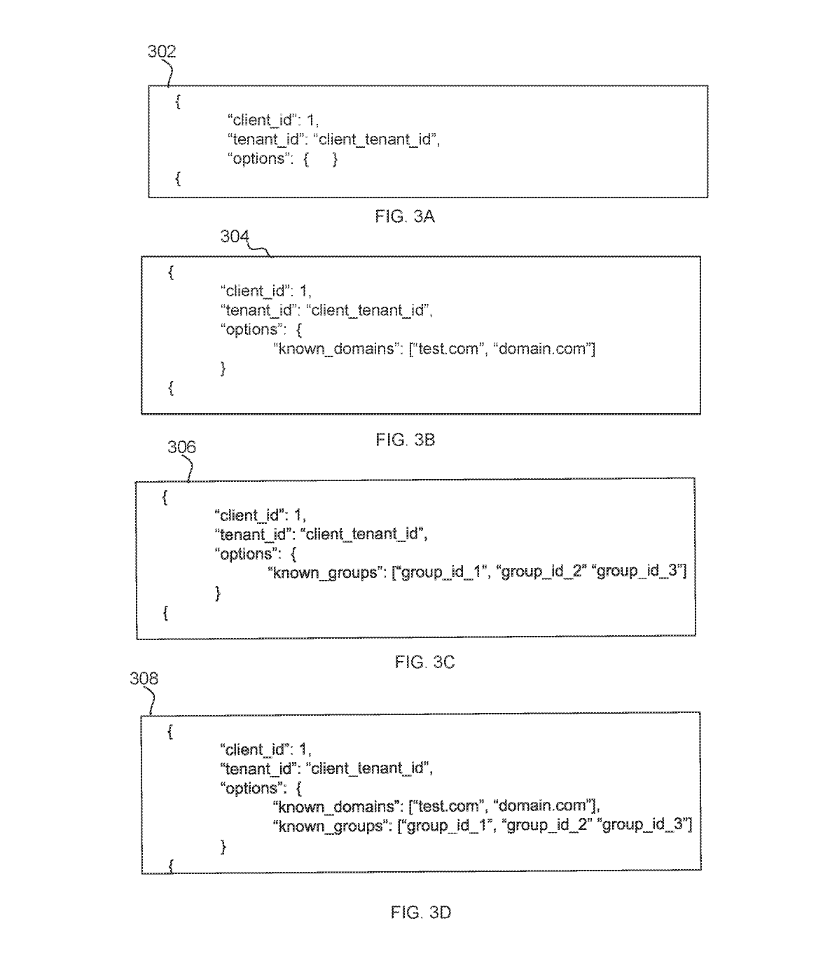

The information included in connection 220 can depend on whether the user elected to limit data capture by user group. Some example embodiments of connections are illustrated in FIGS. 3A-3D. According to one embodiment, a connection is an object for controlling data capture. Turning briefly to FIG. 3A, connection 302 includes, for example, the tenant id of the target tenant. In this example, connection 302 does not include any options for controlling the users for which data is captured. Thus, connection 302 may represent a connection for which the user elected not to limit data capture by user group and for which no other user selected or system inserted options are applied.

In the example of FIG. 3B. connection 304 includes options for controlling the users in the target tenant for which to capture data. More particularly, the options include domains. In some embodiments, the domains used for limiting data capture are not exposed to the user who creates or otherwise configures the connection but are specified by the system. In other embodiments, the user who creates or otherwise configures the connection is provided with the option to select domains.

In the example of FIG. 3C, connection 306 includes options for controlling the users in the target tenant for which to capture data, more particularly, includes several user groups as options (e.g., indicated by user group names). Connection 306 can thus represent a connection for which the user elected to limit data capture by user groups.

In connection 308 of FIG. 3D, the specified options for controlling the users in the target tenant for which to capture data include several user groups (e.g., indicated by user group names) and domains. Connection 308 can thus represent a connection for which the user elected to limit data capture by user groups and for which the system or user added several domains. As discussed, in some embodiments, the domains used for limiting data capture are not exposed to the user who creates or otherwise configures the connection but are specified by the system. In other embodiments, the user who creates or otherwise configures the connection is provided with the option to select domains or other options for controlling data capture.

Returning to FIG. 2, connections stored in connection store 216 are synchronized to a capture database 218 used by capture component 204. For example, connection 220 may be synchronized to database 218. Scheduling information (e.g., schedule 221, initial time 223) and other information used in capture (e.g., tokens, secrets, etc.) may also be stored in capture database 218 in some embodiments.

Capture component 204 comprises a plurality of workers, such as capture worker 222, user capture worker 224, and data retrievers 226 (e.g., data retriever 226a, data retriever 226b). In one embodiment, data retrievers 226 may be specific to retrieving particular types of data or data from particular types of logical containers. Capture component 204 may, for example, include different data retrievers 226 for retrieving messages, files or other content from logical containers such as spaces, channels, workspaces, teams, projects, organizations, hubs. In some embodiments, one or more data retrievers 226 retrieve data from collaboration units.

Data capture may occur based on scheduled jobs. According to one embodiment, capture component 204 keeps a record of the last time data captured occurred according to a job such that, when data capture is performed according to the job, data retrievers 226 use the last timestamp of when the job was last performed and capture data going forward from there (or from a short time prior to the timestamp to help ensure that no data is missed). Scheduling information, such as schedule 221 for a job and the last timestamp of when capture was performed according to the job may be stored in the capture database 218. When a new capture is performed for a job, capture worker 222 updates the timestamp of when capture was last performed according to the job with the current time.

Capture worker 222 processes archive jobs to select connections, such as connection 220, for processing. For an archive job, capture worker 222 passes capture information to user capture worker 224. The capture information includes information related to performing a capture according to the archive job. In particular, the capture information includes the connection information from a retrieved connection. The capture information may also include, for example, scheduling information, such as a timestamp to control how far back data capture is to be performed. In some embodiments, the capture information includes information needed to access data from the multitenant system. User capture worker 224 determines the target users for which to capture data and passes the target users and capture information to data retrievers 226.

If the connection information does not include options for controlling the users for which data is to be captured, user capture worker 224 calls interface 212 to determine all the users in the target tenant and passes these users to data retrievers 226 as the target users for the archive job. Thus, data retrievers 226 will call interface 212 to capture data for all the users in the target tenant.

If, on the other hand, the connection information does include options for controlling the users for which data is captured, user capture worker 224 can limit the target users based on the options.

Using the example of connection 304 from FIG. 3B, user capture worker 224 calls interface 212 to retrieve the set of users in the target tenant having test.com email addresses and the users in the target tenant having domain.com email addresses and passes resulting users to data retrievers 226 as the target users for the archive job.

Using the example of connection 306 from FIG. 3C, user capture worker 224 calls interface 212 to retrieve the members of the group having group_id_1, members of the group having group_id_2 and the members of the group having group_id_3 and passes resulting users to data retrievers 226 as the target users for the archive job.

Using the example of connection 308 from FIG. 3D, user capture worker 224 calls interface 212 to retrieve the set of users in the target tenant having test.com email addresses, the users in the target tenant having domain.com email addresses, the users who are members of the group having group_id_1, members of the group having group_id_2 and the members of the group having group_id_3 and passes resulting users to data retrievers 226 as the target users for the archive job.

As will be appreciated, an individual user may fit multiple capture options. For example, a user may be a member of multiple groups specified in the options or a user may be associated with a domain specified in the options and also be a member of one or more groups specified in the options. User capture worker 224, according to one embodiment, can perform deduplication (e.g., based on username, email address or other identifier that uniquely identifies a user in the multitenant system) to limit the retrieved users passed as target users to unique users without duplication. In some embodiments, deduplication is performed as part of the call to retrieve the users.

The manner in which data retrievers 226 retrieve data for target users can vary based, for example on the implementation of the multitenant system, the type of logical container, or other factors. Using an example in which data retriever 226a retrieves chat messages from Microsoft Teams® chats, data retriever 226a, according to one embodiment, can make calls to interface 212 to retrieve all the chat messages for each target user within the relevant time period for the job. Using an example in which data retriever 226b retrieves channel messages from Microsoft Teams® channels, data retriever 226b, according to one embodiment captures, can make calls to interface 212 to determine the channels of which each target user is a member and for any channel of which a target user is a member retrieve all the channel messages or the relevant time period.

Data retrievers 226, in some embodiment, use a timestamp to control how far back to capture data. For example, the timestamp may indicate an earliest time from which to capture data for a job (e.g., an initial time 223) or indicate when a capture for the job was last performed. Data retrievers 226 capture data going forward from the time indicated in the timestamp (or from a short time prior to that time).

If capture was not previously performed according to the job, the data retrievers 226 can perform an initial capture for a job. As discussed, an archive job, in some embodiments, may have an associated initial time (e.g., initial time 223) which can be used be used as the timestamp for controlling how far back the initial capture for an archive job is performed. In such an embodiment, data retrievers capture data going forward from the specified initial time (or from a short time prior). In other embodiments, data retrievers 226 make calls to retrieve all the relevant data going back indefinitely or as far as the multitenant system will allow up to the current time. In another embodiment, the data retrievers 226 retrieve data for a predefined time period (e.g., starting a year prior to the current time, five years prior time, or other time prior to the current time and going forward from there).

Data retrievers 226 provide captured data archiving application 206 for storage in archival storage 208. Archiving application 206 can archive captured data using an archiving format. In one embodiment, data retrievers send captured data to archiving application 206 by email using envelope journaling format.

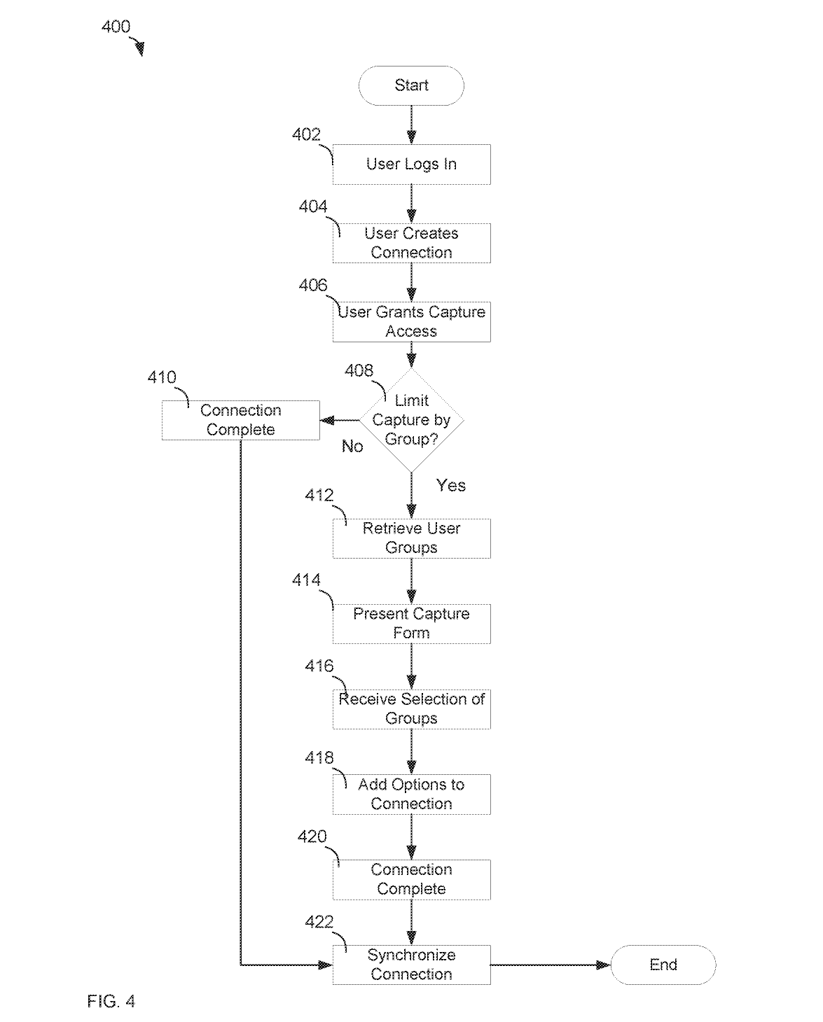

FIG. 4 is a flow chart illustrating one embodiment of a method 400 for configuring a capture system to capture data from a multitenant system. One or more steps of method 400 may be embodied as computer-translatable instructions stored on a non-transitory, computer-readable medium. One or more steps of method 400 may be performed by a capture system, such as capture system 200 of FIG. 2. Even more particularly, one or more of the steps of method 400 may be performed by web application 202.

At step 402, a user logs in to a configuration interface of a capture system, such as provided by web application 202. At step 404, the user creates a connection (e.g., connection 220) for a target tenant. In one embodiment, the user provides a tenant id for a target tenant. At step 406, the capture system receives a grant of capture access to the tenant. According to one embodiment, the user grants the capture system tenant level access to the target tenant.

At step 408, the capture system presents the user with the option to limit data capture by user group. If the user elects not to control data capture by user group, the connection may be considered complete and the capture system stores the connection to a connection store (step 410). In some embodiments, the capture system adds system selected options for controlling data capture to the connection even if the user does not elect to control data capture by group.

If the user elects to control data capture by user group, the capture system, at step 412, uses its capture access (e.g., tenant level access) to retrieve the user groups of the target tenant from the multitenant system. For example, web application 202 collects the user groups of the target tenant through interface 212 of the multitenant system. According to one embodiment, the capture system, at this point, simply collects the names or other identifiers of the user groups, but not the identities of the group members.

At step 414, the capture system presents the user with a capture form which, for example, allows the user to select user groups. Based on user interaction with the user interface, the capture system receives a selection of one or more user groups (step 416) and adds the user groups to the connection (e.g., connection 220). In some embodiments, the capture system may also receive a selection of other options for limiting data capture, such as one or more domains. The options for limiting data capture, whether user specified or system determined, can be stored in the connection (step 418). When the user indicates that they are done configuring the connection, the connection may be considered complete and, for example, stored to a connection store (step 420). In some embodiments, the user may also specify a capture schedule for an archive job that uses the connection.

At step 422, the connection can be synchronized with the capture and archive component database. For example, connection 220 can be synchronized to database 218. The scheduling information may also be synchronized.

FIG. 4 is merely an illustrative example, and the disclosed subject matter is not limited to the ordering or number of steps illustrated. Embodiments may implement additional steps or alternative steps, omit steps, or repeat steps.

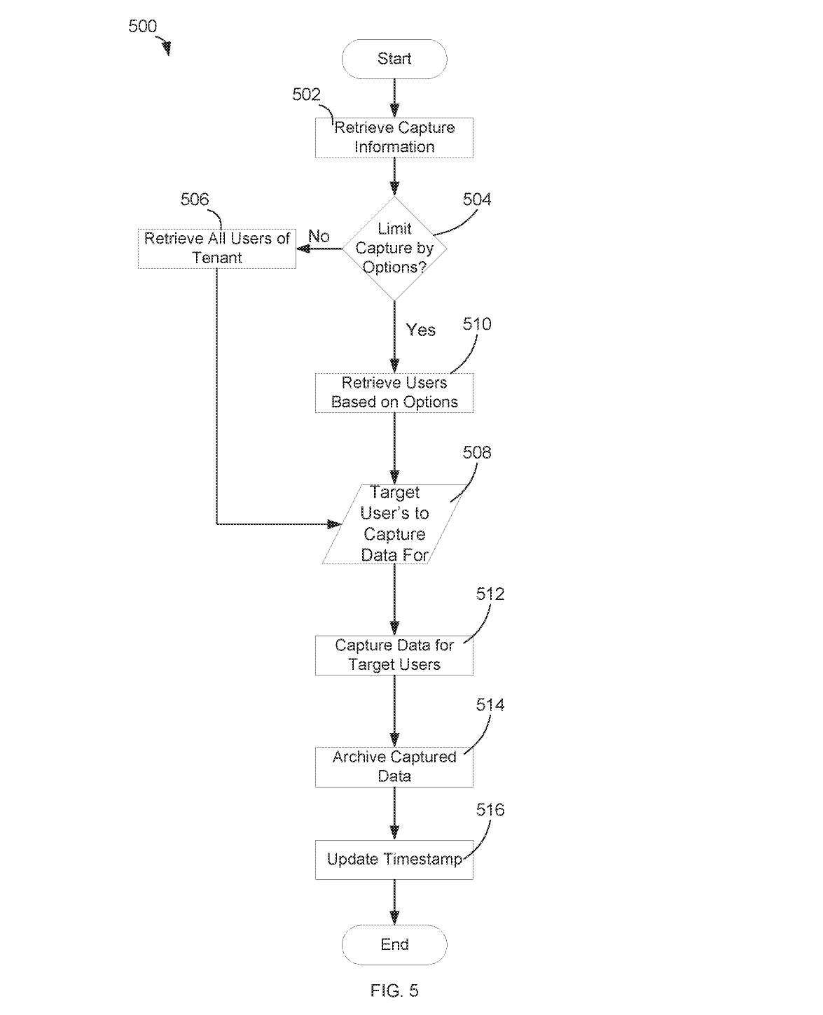

FIG. 5 is a flow chart illustrating one embodiment of a method 500 for data capture from a multitenant system. As will be appreciated, capture may be performed according to an archive job. One or more steps of method 500 may be embodied as computer-translatable instructions stored on a non-transitory, computer-readable medium. One or more steps of method 500 may be performed by a capture system, such as capture system 200 of FIG. 2. For example, one or more steps of method 500 may be performed by capture component 204.

At step 502, the capture system retrieves capture information. The capture information, according to one embodiment, includes a connection (e.g., connection 220) and scheduling information for a job, such as a timestamp for controlling how far back data capture is to be performed. The capture information, in some embodiments, includes information needed to retrieve data from the target multitenant system.

At step 504, the capture system determines if the connection information includes options for controlling the users in the target tenant for which data is to be captured. If no options are specified for limiting the user for which data is to be captured, the capture system can retrieve all the users in the target tenant (step 506). For example, user capture worker 224 calls interface 212 to determine all the users in the target tenant. The users returned for the target tenant are provided as target users 508. If, on the other hand, the connection information includes options to control the users in the target tenant for which data is to be captured, the capture system retrieves users based on the options (step 510). For example, user capture worker 224 calls interface 212 to retrieve the users in the target tenant having email addresses in specified domains or users who are members of specified groups. User capture worker 224 provides the retrieved users as target users 508 for capture and archiving. In some embodiments, deduplication is performed such that the retrieved users provided as target users 508 are unique users. At step 512, data for the target users is captured from the multitenant platform. For example, data retrievers 226 retrieve content (e.g., messages, files, or other types of content) from logical containers such as containers, spaces, channels, workspaces, teams, projects, organizations, or hubs based on the target users 508. In some embodiments, data is captured for a period moving forward from when a capture for a job was last performed for the job (or from a short time prior). In one embodiment, if capture was not previously performed according to the job, data capture is performed to capture data from an initial time specified for the job (or from a short time prior) up to a current time is captured. In another embodiment, if capture was not previously performed according to the job, all the relevant data up to a current time is captured. In another embodiment, if capture was not previously performed according to the job, all the relevant data from a predefined time (e.g., one year ago, five years ago) up to the current time is captured.

The captured data is archived (step 514). According to one embodiment, captured data is archived using email. For example, captured data can be archived using envelope journaling format.

At step 516, the timestamp indicating when data capture was last performed according to the job is updated.

FIG. 5 is merely an illustrative example, and the disclosed subject matter is not limited to the ordering or number of steps illustrated. Embodiments may implement additional steps or alternative steps, omit steps, or repeat steps.

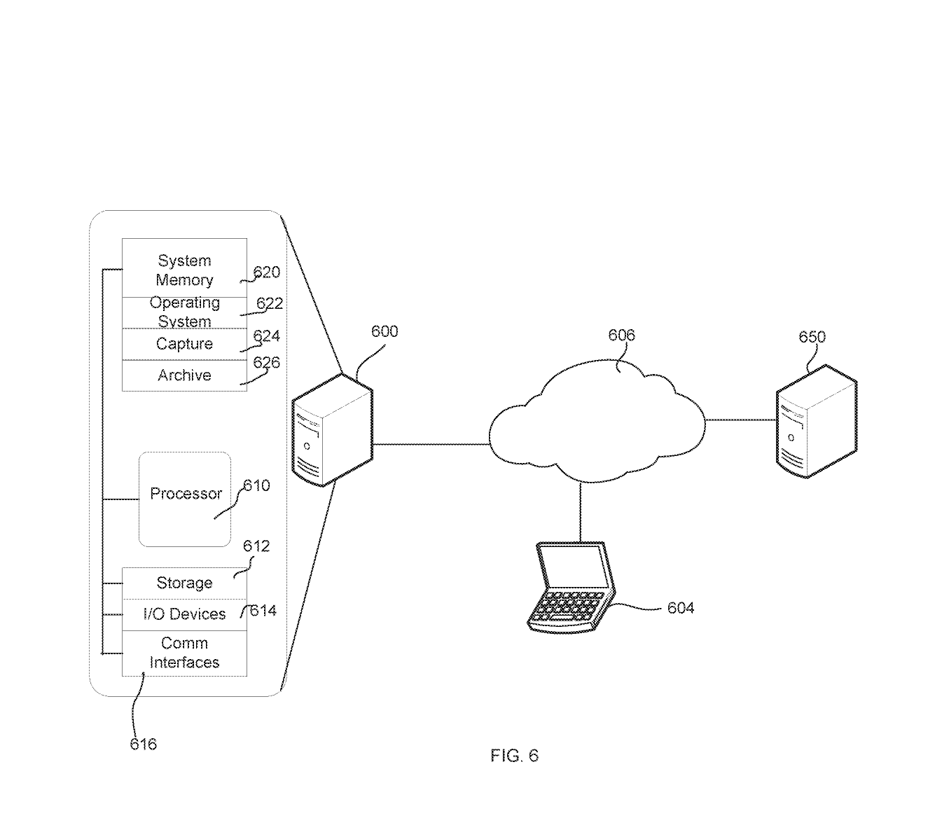

FIG. 6 illustrates one embodiment of a computer system 600. Computer system 600 includes a processor 610 and memory 620. Depending on the exact configuration and type of computing device, memory 620 (storing, among other things, executable instructions) may be volatile (such as RAM), non-volatile (such as ROM, flash memory, etc.), or some combination of the two. Further, computer system 600 may also include storage devices 612, such as, but not limited to, solid state storage. Similarly, computer system 600 may also have input device(s) and output device (I/O devices 614) such as keyboard, mouse, pen, voice input, touch screen, speakers, or other I/O devices. Computer system 600 further includes communications interfaces 616, such as a cellular interface, a Wi-Fi interface, or other interfaces.

Computer system 600 includes at least some form of non-transitory computer-readable media. The non-transitory computer-readable readable media can be any available media that can be accessed by processor 610 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 620. While executing on processor 610, program modules (e.g., applications, Input/Output (I/O) management, and other utilities) may perform processes including, but not limited to, one or more of the stages of the operational methods described with respect to capture service 126, archive service 128, or capture system 200. In one embodiment, system memory 620 stores an operating system 622, a capture application 624 executable to provide a capture system, such as capture system 200, and an archiving application 626, such as archiving application 206. Computer system 600 connects to remote multitenant system 650 and client computer 604 by a network 606. And end-user at client computer 604 can configure capture application 624 to capture data. Capture application 624 is executable to capture data from a remote multitenant system 650. Captured data is provided to archiving application 626 for storage in archival data storage.

Some embodiments may be practiced in an electrical circuit comprising discrete electronic elements, packaged or integrated electronic chips containing logic gates, a circuit utilizing a microprocessor, or chip single chip containing electronic elements or microprocessors. For example, examples of computer system 600 may be practiced via a system-on-a-chip (SOC) where each or many of the components of computer system 600 may be integrated onto a single integrated circuit. Such an SOC device may include processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment on the single integrated circuit (chip).

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A computer-implemented method for archiving from a multitenant environment comprising:
provisioning capture permissions for capturing data from a multitenant system;
receiving an indication of a target tenant;
querying the multitenant system to retrieve user groups of the target tenant;
receiving a selection of a user group from the retrieved user groups as an option for controlling data capture;
determining target users in the target tenant, wherein determining the target users in the target tenant comprises:
based on the selection of the user group as the option for controlling data capture, querying the multitenant system to retrieve members of the user group;
capturing data for the target users of the user group from the multitenant system to generate captured data; and
archiving the captured data.

2. The computer-implemented method of claim 1, wherein the capture permissions are tenant-level permissions for the target tenant.

3. The computer-implemented method of claim 1, wherein capturing data for the target users from the multitenant system to generate the captured data comprises capturing data from a logical container associated with one or more of the target users.

4. The computer-implemented method of claim 3, wherein the logical container is a collaboration unit.

5. The computer-implemented method of claim 1, wherein capturing data for the target users from the multitenant system to generate the captured data comprises capturing messages of the target users.

6. The computer-implemented method of claim 1, further comprising:
determining a domain for controlling data capture, wherein determining the target users in the target tenant comprises querying the multitenant system for users in the target tenant associated with the domain.

7. The computer-implemented method of claim 6, wherein the users in the target tenant associated with the domain each have an email address at the domain.

8. The computer-implemented method of claim 1, wherein archiving the captured data comprises sending the captured data to an archiving application as emails using an envelope journaling format.

9. A non-transitory, computer-readable medium storing thereon software code for capturing data from a multitenant environment, the software code comprising instructions translatable by a processor for:
provisioning capture permissions for capturing data from a multitenant system;
receiving an indication of a target tenant;
querying the multitenant system to retrieve user groups of the target tenant;
receiving a selection of a user group from the retrieved user groups as an option for controlling data capture;
determining target users in the target tenant, wherein determining the target users in the target tenant comprises:
based on the selection of the user group as the option for controlling data capture, querying the multitenant system to retrieve members of the user group;
capturing data for the target users in the multitenant system to generate captured data; and
archiving the captured data.

10. The non-transitory, computer-readable medium of claim 9, wherein the capture permissions are tenant-level permissions for the target tenant.

11. The non-transitory, computer-readable medium of claim 9, wherein capturing data for the target users from the multitenant system to generate the captured data comprises capturing data from a logical container associated with one or more of the target users.

12. The non-transitory, computer-readable medium of claim 11, wherein the logical container is a collaboration unit.

13. The non-transitory, computer-readable medium of claim 9, wherein capturing data for the target users in the multitenant system to generate the captured data comprises capturing messages of the target users.

14. The non-transitory, computer-readable medium of claim 9, further comprising instructions translatable by the processor:
determining a domain for controlling data capture, wherein determining the target users in the target tenant comprises querying the multitenant system for users in the target tenant associated with the domain.

15. The non-transitory, computer-readable medium of claim 14, wherein the users in the target tenant associated with the domain each have an email address at the domain.

16. The computer-implemented method of claim 1, wherein archiving the captured data comprises sending the captured data to an archiving application as emails using an envelope journaling format.

17. A data capture system comprising:
a processor;
a memory coupled to the processor, the memory storing:
a connection, the connection comprising:
an indicator of a target tenant; and
a capture control option; and
software code translatable to provide a software-based capture system comprising:
a first worker, wherein the first worker is executable to retrieve the connection;
a user capture worker, wherein the first worker is executable to pass connection information to the user capture worker, wherein the user capture worker is executable to call an interface of a multitenant system to retrieve target users associated with the capture control option in the target tenant;
a data retriever, wherein the data retriever receives the target users from the user capture worker, and wherein the data retriever is executable to:
capture data for the target users from logical containers at the multitenant system to generate captured data; and
send the captured data to an archiving application as emails using an envelope journaling format.

18. The data capture system of claim 17, wherein the capture control option is a user group.

19. The data capture system of claim 17, wherein the capture control option is a domain.

20. The data capture system of claim 17, further comprising a web application, wherein the web application is executable to allow a user, through user interaction with the web application, to:
create the connection;
grant to the software-based capture system, capture access to the multitenant system; and
specify the capture control option.
